(19) United States
(12) Patent Application Publication
(10) Pub. No.: US 2026/0038755 A1
(43) Pub. Date: Feb. 5, 2026

(54) RC ARRANGEMENTS FOR SWITCHING INDUCTIVE CURRENTS, USING HIGH-VOLTAGE VACUUM SWITCHES

(71) Applicant: Siemens Energy Global GmbH & Co. KG, München (DE)

(72) Inventors: Thomas Heinz, Berlin (DE); Stefan Giere, Falkensee (DE); Jan Weisker, Brieselang (DE); Rene Schaefer, Bergfelde (DE)

(21) Appl. No.: 19/100,647

(22) PCT Filed: Jul. 20, 2023
(86) PCT No.: PCT/EP2023/070106

§ 371 Date: Feb. 3, 2025

(30) Foreign Application Priority Data
Aug. 2, 2022 (DE) 10 2022 207 958.2

(51) Int. Cl. H01H 33/16; H01H 33/02; H01H 33/66

(52) U.S. Cl. CPC H01H 33/16; H01H 33/027; H01H 33/6606

(57) ABSTRACT

An electrical circuit device is particularly configured for the wiring in high-voltage switching devices for the high-voltage energy transfer using RC arrangements. Vacuum switching devices are thereby made suitable for use in inductor switching applications in the high-voltage range greater than or equal to 72.5 kilovolts.

The invention relates to the wiring of electrical devices, in particular high-voltage switching devices, for high-voltage energy transmission using RC arrangements.

Particular protective measures are required when switching small inductive currents, as arise in inductor applications in high-voltage networks (>=72.5 kV). The switching duty involves the risk of transient overvoltages being able to destroy the components of the electrical substation. In this case, specifically the inductor itself is subject to a certain degree of danger. Examples of switching media given are gas switches and vacuum switch apparatuses.

Predominantly SF6 circuit breakers are used in high-voltage networks. In these application cases, the gas switches are not operated without additional protective measures. These measures are used to reduce the overvoltages arising during the switching process.

Until now, applications for inductor switching in high-voltage networks (>=72.5 kV) have been operated using a combination of an electronic controller (controls the exact time of switch-on or switch-off) and an SF6 circuit breaker with single-pole operation. The solution is costly, requires an increased degree of outlay upon start-up and involves the risk of the circuit breaker data that are stored in the controller, such as the inherent delays of the switch, for example, changing over the course of operation—over decades. The optimum switching time could thus be changed and the function of the arrangement of the single-pole-operated circuit breaker and the electronic controller could be adversely affected.

The invention is based on the object of specifying solutions for enabling the use of vacuum switching apparatuses in the high-voltage range (>=72.5 kV) instead of gas switches and, furthermore, the use of multipole switching apparatuses for inductor switching applications.

The problem is solved by way of a device for high-voltage electrical energy transmission comprising the features of claim 1.

The use of an RC filter circuit (series circuit composed of a resistor R and a capacitor C) may significantly reduce the effect of transient overvoltages. Such a solution has been used at medium voltage for many years and is thus prior art. Consequently, RC filter circuit components for the medium-voltage level are also available.

Transferring this technology to the higher voltage levels (>=72.5 kV) makes it possible to use vacuum switching apparatuses instead of gas switches for inductor switching applications in the high-voltage range.

The RC filter circuit elements may in this case be effected by way of an interconnection of existing discrete RC components (for example RC elements in a metal-encapsulated housing (“can”) with oil insulation), as are already currently used at medium voltage. As an alternative, it is possible to integrate the RC elements into existing or newly designed high-voltage components for gas-insulated (GIS) or air-insulated (AIS) applications.

The RC filter circuit may advantageously be integrated into existing or newly designed high-voltage elements or the existing high-voltage modules may be extended/supplemented by appropriate parts. It is advantageous in this case that the RC elements do not have to have a separate outdoor housing (for example metal-encapsulated housing with bushing) due to the integration into the high-voltage components. This results in advantages in terms of outlay and space.

Multipole switching apparatuses may be controlled using just one drive.

Advantageous developments of the invention are specified in the dependent claims.

The invention is explained in more detail below as an exemplary embodiment to an extent required for understanding based on figures.

In the figures:

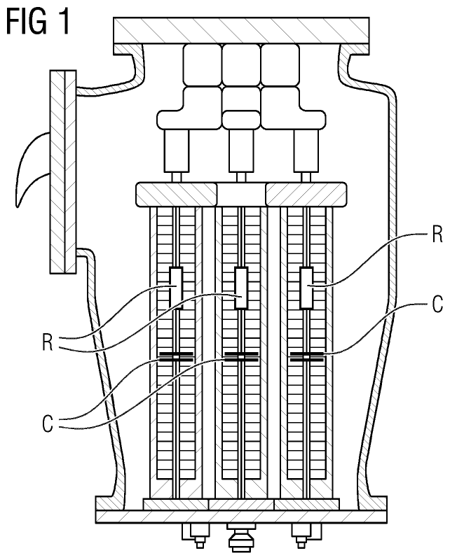

FIG. 1 shows a three-pole, gas-insulated high-voltage device according to the invention with individual resistor disks and capacitors,

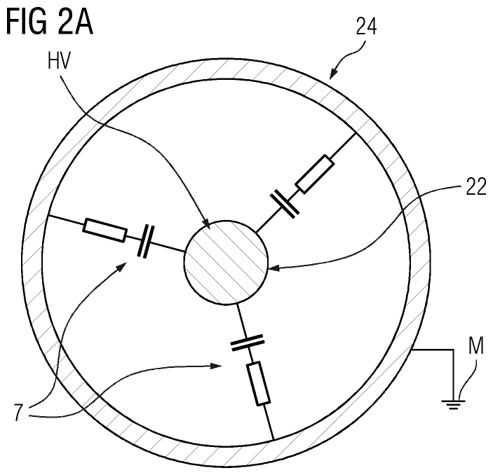

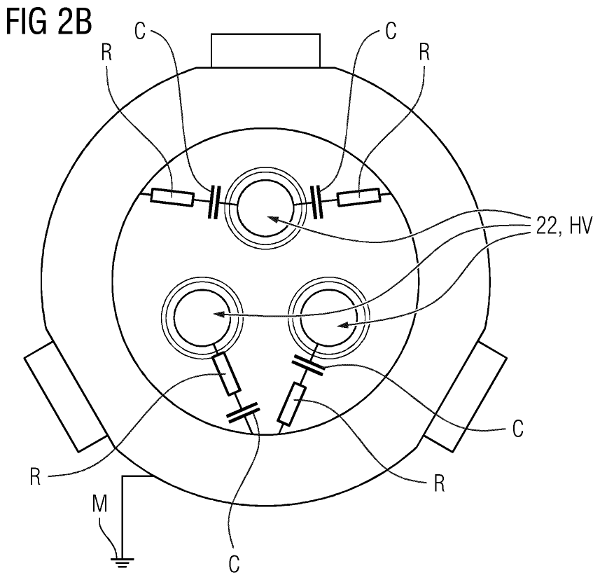

FIG. 2a shows a single-pole high-voltage cast-resin bushing according to the invention with RC circuits,

FIG. 2b shows a three-pole high-voltage cast-resin bushing according to the invention with RC circuits,

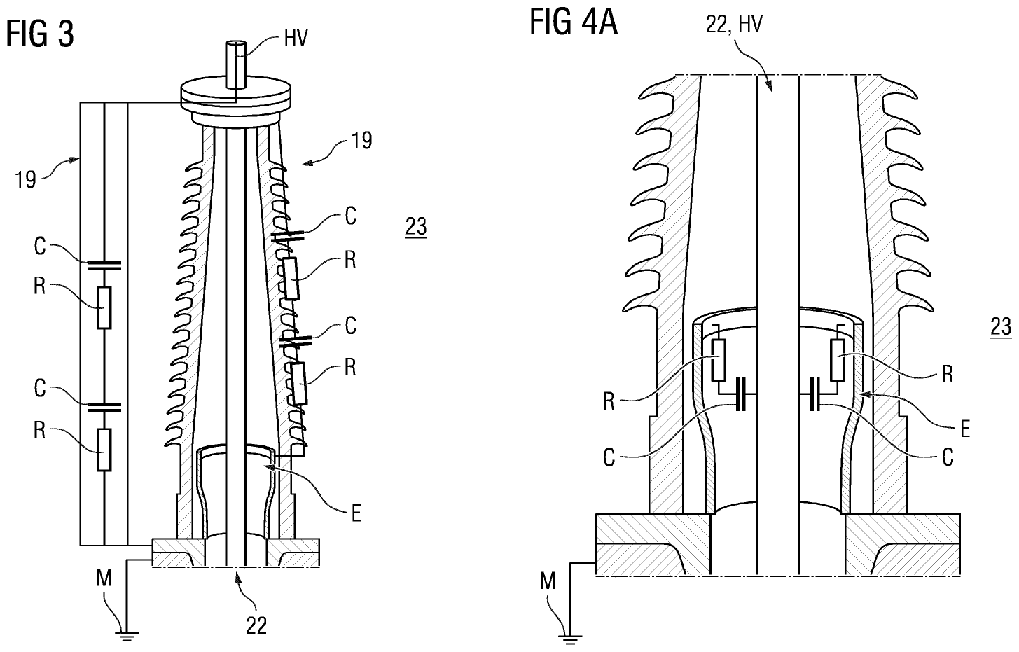

FIG. 3 shows a high-voltage bushing according to the invention in two embodiment variants,

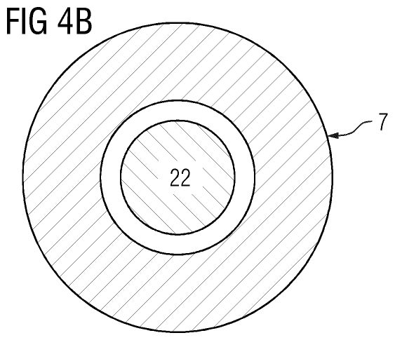

FIG. 4a shows a high-voltage bushing according to the invention with RC elements integrated into the sheath,

FIG. 4b shows RC element disks arranged according to the invention concentrically with respect to the conductor,

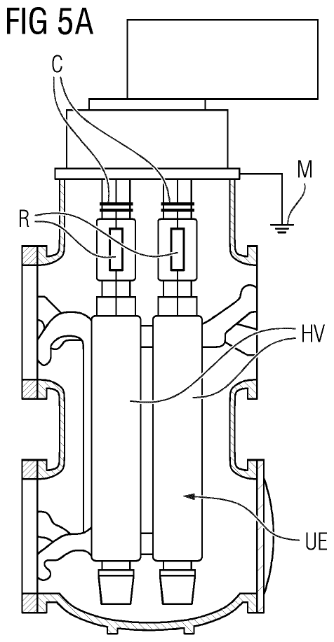

FIG. 5a shows a high-voltage circuit breaker according to the invention with RC elements integrated into the insulated support on the drive side,

FIG. 5b shows a high-voltage circuit breaker according to 28 the invention with RC elements integrated into the insulated support on the fixed-contact side,

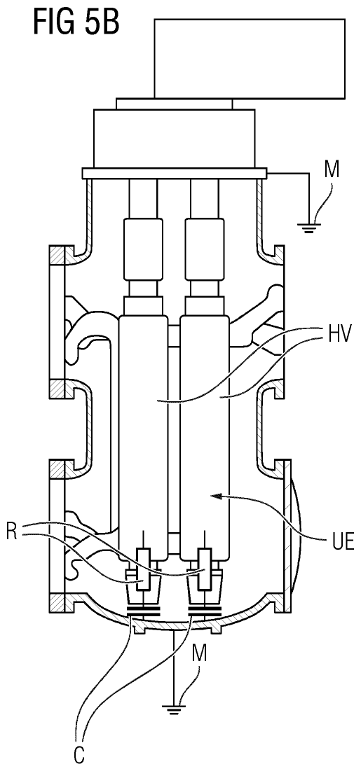

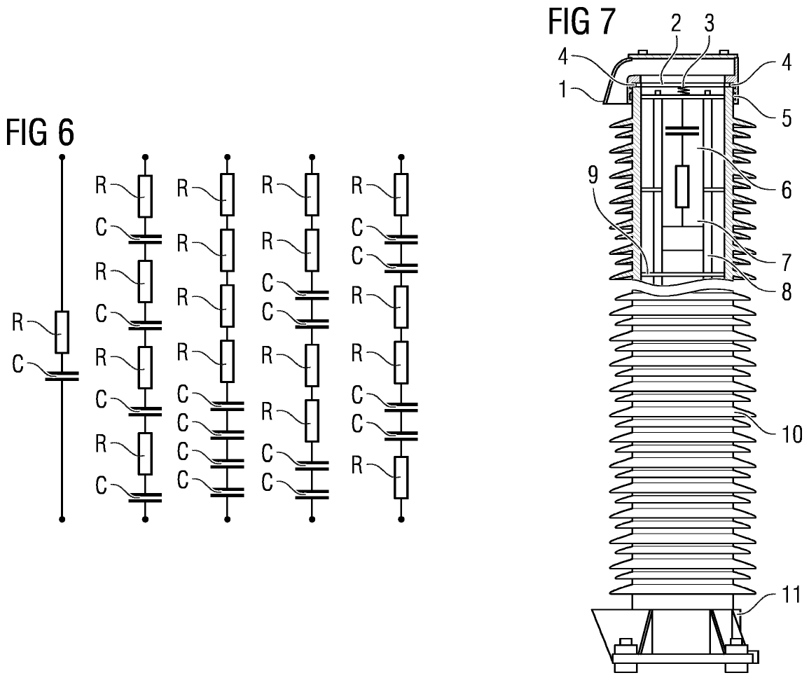

FIG. 6 shows variants of combinations of RC elements according to the invention,

FIG. 7 shows a first air-insulated high-voltage arrester housing according to the invention with individual resistor disks and capacitors,

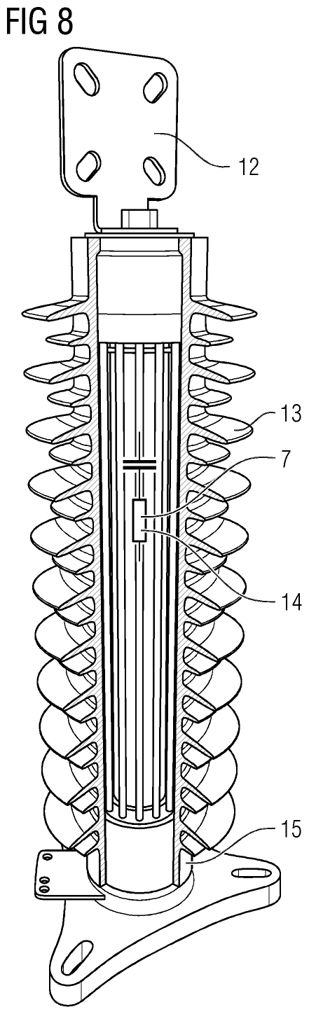

FIG. 8 shows a second air-insulated high-voltage arrester housing according to the invention with individual resistor disks and capacitors,

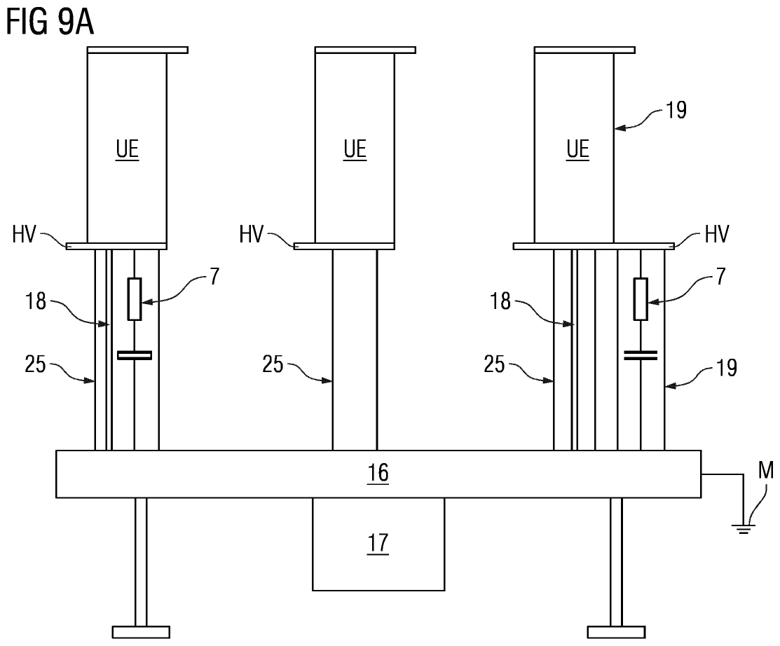

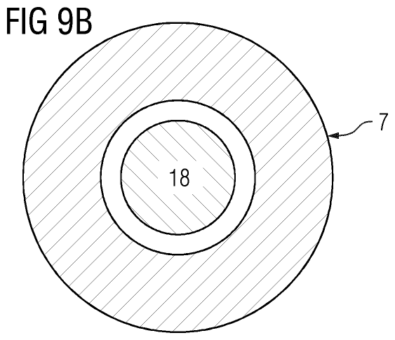

FIG. 9a shows a live tank circuit breaker according to the invention with integrated RC elements,

FIG. 9b shows RC element disks arranged according to the invention concentrically with respect to the operating rod,

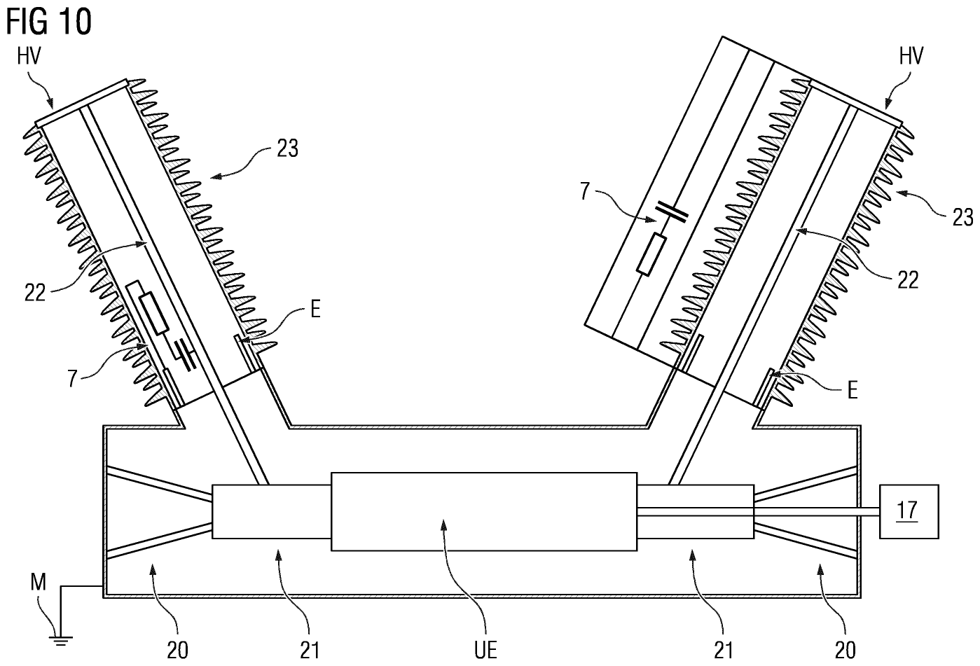

FIG. 10 shows a dead tank circuit breaker according to the invention with RC elements integrated into the bushing, and

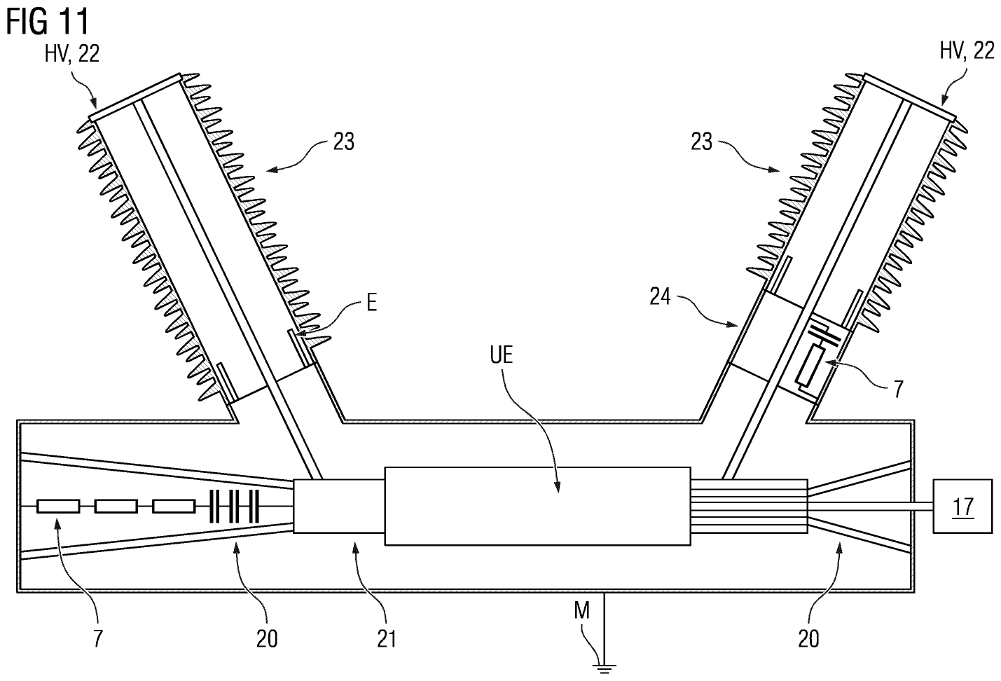

FIG. 11 shows a dead tank circuit breaker according to the invention with RC elements integrated into the support.

In the figures, the same references denote the same elements.

The invention may be used in gas-insulated applications (GIS), which fall under the category of tank applications.

In the gas-insulated high-voltage device shown in FIG. 1, which may be of single-pole or multipole design, a conventional arrestor is modified in such a way that, instead of arrestor resistors, such as metal oxide (MO) resistors, for example, individual resistor disks R and capacitors C are arranged.

FIG. 2a and FIG. 2b show a single-pole cast-resin bushing and a three-pole cast-resin bushing, respectively, in which the RC elements are integrated in such a way that they are molded in cast resin. In this case, a conductor 22, which is supplied with high voltage, is connected to ground M via a respective RC element. A cast-resin bushing according to the invention may be combined with an LPIT—low power instrument transformer.

The high-voltage bushing/terminal lead 23 of a gas-insulated switchgear assembly shown in FIG. 3 illustrates two embodiments in which the RC elements are arranged in parallel with the bushing. As illustrated on the right of FIG. 3, the RC elements may be integrated into the sheath of the bushing, on the one hand on the inner surface of the bushing or the other hand in the solid material (ceramic, composite, silicone, etc.) of the bushing. As illustrated on the left of FIG. 3, the RC elements may be arranged in a stacked manner in a separate sheath 19, wherein gas, liquid or solid insulation may be used for the RC elements.

In the high-voltage bushing/terminal lead 23 of a gas-insulated switchgear assembly shown in FIG. 4a, the RC elements are integrated into the sheath of the bushing, wherein the conductor 22 is connected via the RC elements to the electrode E, which is connected to ground M, or the outer housing of the bushing, which is connected to ground M. As illustrated in FIG. 4b, the RC elements may be arranged in a stacked manner around the conductor 22 as coaxial elements. In the embodiment according to FIG. 4a, the diameter and/or the length of the area of the bushing/terminal lead, where the RC elements are arranged, may be designed to be enlarged compared to a conventional bushing/terminal lead.

In the high-voltage circuit breaker shown in FIG. 5a, RC elements are arranged in the insulated support on the drive side of an interrupter unit UE. In the high-voltage circuit breaker shown in FIG. 5b, RC elements are arranged in the insulated support on the fixed-contact side of an interrupter unit UE. The RC elements, which are connected in series between high voltage HV and ground M, may be molded in the insulated support, wherein solid insulation is provided. The RC elements may be arranged in the gas chamber parallel to the support material of the insulated support.

FIG. 6 shows combination variants of RC elements according to the invention. The RC interconnection may be effected differently depending on design, but also on application, for example smaller and smaller RC elements in alternation, a large R and a large C element, different combinations of R and C elements (for example 2×R, 2×C), symmetrical or asymmetrical.

The invention may be used in air-insulated applications (AIS).

In the embodiment shown in FIG. 7, instead of the conventional arrestor resistors, such as metal oxide (MO) resistors, for example, individual resistor disks R and capacitors C are arranged according to the invention in an air-insulated high-voltage arrester housing in a stacked manner and in a gas-insulated, liquid-insulated or solid-insulated manner.

In the embodiment shown in FIG. 8, instead of the conventional arrestor resistors, such as metal oxide (MO) resistors, for example, individual resistor disks R and capacitors C are arranged according to the invention in an air-insulated high-voltage arrester housing in an insulated manner. The resistor disks R and the capacitors C are spaced apart from the insulation housing 13 that concentrically surrounds them by means of GRP bars arranged concentrically around them in an evenly distributed manner.

The live tank circuit breaker shown in FIG. 9a may be of single-pole or multipole, in particular three-pole, design. An interrupter unit UE in the sheath is supported by a base 16 via an insulating support column 25 and, via an insulating operating rod 18 arranged in the support column, is able to be actuated by a drive 17 and a gear mechanism accommodated in the base 16. In the interrupter unit illustrated on the left of FIG. 9a, RC elements are arranged in the support column 25 next to the operating rod. In the interrupter unit illustrated on the right of FIG. 9a, a separate RC column is arranged in a separate sheath 19 next to a support column 25 with operating rod 18. RC elements with gas, liquid or solid insulation may be arranged in the RC column.

In the interrupter unit illustrated in the center of FIG. 9a, as illustrated in more detail in plan view in FIG. 9b, RC elements 7 are arranged as RC disks in a stacked manner in the support column concentrically with respect to the operating rod 18.

In the dead tank circuit breaker illustrated in FIG. 10, an interrupter unit UE is secured in a housing that is connected to ground M by means of insulated supports 20 and is able to be actuated by way of a drive 17. RC elements 7 are integrated into a bushing 23. The bushing illustrated on the left of FIG. 10 may be provided by way of a high-voltage bushing/terminal lead described for FIG. 4. The bushing 23 illustrated on the right of FIG. 10 may be provided by way of a high-voltage bushing/terminal lead described for FIG. 3.

In the dead tank circuit breaker illustrated in FIG. 11, an interrupter unit UE is secured by means of insulated supports 20 in a housing that is connected to ground M. RC elements 7 are integrated into the insulated support furthest away from the drive 17, on the fixed-contact side of the interrupter unit. RC elements 7 may be integrated into the insulated support close to the drive, on the drive side of the interrupter unit.

A cast-resin bushing 24 according to the embodiment of FIG. 2a is arranged between the bushing 23 illustrated on the right of FIG. 11 and the housing flange. RC elements are integrated into the cast-resin bushing in such a way that they are molded in cast resin. The cast-resin bushing may be combined with an LPIT-low power instrument transformer.

The dead tank applications illustrated in FIG. 10 and FIG. 11 fall under the category of tank applications. The dead tank circuit breakers illustrated in FIG. 10 and FIG. 11 may be of single-pole or multipole, in particular three-pole, design.

An interrupter unit UE may comprise a high-voltage switch, in particular a high-voltage vacuum switch.

The inventive wiring of electrical devices for high-voltage energy transmission using RC arrangements forms a protective circuit for high-voltage switching devices, in particular high-voltage vacuum switches.

In the context of the invention, high voltage is understood to mean a voltage of 72.5 kV (kilovolts) and more, comprising DC voltage, AC voltage, and also alternating current if three-pole.

The present invention has been explained in detail for illustrative purposes based on specific exemplary embodiments. In this case, elements of the individual exemplary embodiments may also be combined with one another. The invention is therefore not intended to be limited to individual exemplary embodiments but only limited by the appended claims.

### LIST OF REFERENCE SIGNS

1 Expulsion opening
2 Pressure relief unit
3 Compression spring
4 Sealing ring
5 Cementing
6 Metallic filler element
7 RC combination
8 Holding rod, glass-reinforced plastic (GRP)
9 Holding plate, glass-reinforced plastic (GRP)
10 Porcelain housing
11 Aluminum flange
12 End fitting with high-voltage connection
13 Silicone shielding
14 GRP bars
15 End fitting with foot, ground
16 Base, gear mechanism
17 Drive
18 Operating rod, insulated rod
19 Sheath
20 Insulated support, support
21 Base
22 Conductor
23 Bushing
24 Cast-resin bushing
25 Support column
AIS Gas-insulated switchgear assembly
C Capacitor, capacitance
E Electrode
DT Dead tank
GIS Gas-insulated switchgear assembly
HV High voltage
LPIT Low power instrument transformer
LT Live tank
M Ground, ground potential
MO Metal oxide
R Electrical resistor
UE Interrupter unit

1-11. (canceled)

12. A device for high-voltage electrical energy transmission, the device comprising:
a series circuit including at least one electrical resistor R and at least one capacitor C, said series circuit being configured to be connected between a high-voltage conductor that conducts a high voltage greater than or equal to (>=) 72.5 kilovolts (KW) and ground.

13. The device according to claim 12 configured as a high-voltage bushing/terminal lead.

14. The device according to claim 13 configured as a cast-resin bushing.

15. The device according to claim 14, wherein said cast-resin bushing is combined with a low power instrument transformer.

16. The device according to claim 13, wherein said high-voltage bushing comprises a sheath, and said series circuit with said at least one electrical resistor R and said at least one capacitor C is integrated in said sheath.

17. The device according to claim 13, which comprises a separate sheath disposed separate of, and in parallel with, said high-voltage bushing, and wherein said series circuit with said at least one electrical resistor R and said at least one capacitor C is arranged in said separate sheath.

18. The device according to claim 12 configured as a high-voltage circuit breaker, and wherein said series circuit with said at least one electrical resistor R and said at least one capacitor C is connected in an insulation support of an interrupter unit.

19. The device according to claim 18, wherein said interrupter unit has a drive side and a fixed-contact side, and wherein said series circuit is connected on the drive side or on the fixed-contact side of said interrupter unit.

20. The device according to claim 12 configured as a live tank circuit breaker, and wherein said series circuit with said at least one electrical resistor R and said at least one capacitor C is arranged parallel with a support column on said live tank.

21. The device according to claim 12 configured as an arrester having, instead of an arrester resistor, said series circuit with said at least one electrical resistor R and said at least one capacitor C.

22. The device according to claim 12 configured as a high-voltage circuit breaker comprising an interrupter unit being a vacuum interrupter.

23. The device according to claim 12, being a multipole device.
